(19) United States
(12) Patent Application Publication
(10) Pub. No.: US 2024/0051321 A1
(43) Pub. Date: Feb. 15, 2024

(54) System and Method for Repairing or Replicating a Building Material

(71) Applicant: Candice Folmar, Lake Elsinore, CA (US)

(72) Inventor: Candice Folmar, Lake Elsinore, CA (US)

(21) Appl. No.: 17/884,454

(22) Filed: Aug. 9, 2022

(51) Int. Cl. B41M 5/00; B28B 11/00; B28B 11/04; G06T 15/20

(52) U.S. Cl. CPC B41M 5/007; B41M 5/0047; B28B 11/001; B28B 11/044; G06T 15/205

(57) ABSTRACT

A system and method for replicating or repairing a building a material may serve as an effective means for repairing or replicating building material that has been discontinued or is otherwise unavailable or unsuitable for installation, the method comprising the steps of scanning an original tile to obtain an image data set, communicating the image data set to a computer, rendering a three-dimensional image of the original tile from the image data set, carving a new tile using a CNC machine based on the three-dimensional image of the original tile, applying a decorative image to the new tile, applying a glaze to the new tile, and firing the new tile.

### FIELD OF THE INVENTION

This disclosure generally relates to tile manufacturing. Specifically, this disclosure relates to a system and method for repairing or replicating a new tile from an existing tile using a combination of 3D scanning, 3D printing, CNC, and image application.

### BACKGROUND

Tiles have been used in the construction of buildings for centuries, both as decorative elements, as well as for functional purposes. Accordingly, tiles have historically been installed both inside and outside of buildings of all types, including homes, businesses, places of worship and more. Ceramic tiles are one of the oldest forms used for decorative art and have survived for centuries due to in part to their durability. The earliest use of decorative tiles was found in Egypt, dating from about 4000 BC. Tiles were also made by the Assyrians and Babylonians, as well as by the Romans and the Greeks. Many great works of art throughout history have been made using tile, including tile work in mosaics, murals and more.

Tile may be formed from a number of different materials. Tiles are most often made of ceramic, but other materials are also commonly used, such as glass, cork, concrete and other composite materials, and stone. Tiling stone is typically marble, onyx, granite or slate. The main ingredients of ceramic tile and its general manufacturing process have remained the same over centuries. Generally, ceramic tiles are created from natural products extracted from the earth that are shaped into tiles and then fired in kilns at extremely high temperatures.

There are generally two main types of tile construction: glazed and unglazed. A glazed tile is made of essentially two layers. The body of the tile, or largest layer, is called the bisque. The top layer is called the glaze. Glazed tiles have a hard non-porous, impermeable surface after firing. Glazed tiles are more stain resistant than unglazed tile and are easier to clean. Unglazed tiles are solid colored all the way through and do not have a top layer of glaze.

Ceramic tiles are typically made of clay, talc and sand, all combined in an appropriate ratio. Porcelain tiles are made of several types of clay, sand and feldspar. The process by which the tiles are made also differs: porcelain tiles are formed using high pressures and are fired at high temperatures (1100-1200° C.). Furthermore, porcelain tiles may be available a wide variety of colors and structures, as well as the option of having the appearance of other materials such as concrete, wood, stone and marble, along with many different finishes.

The traditional tile manufacturing process can be broadly broken down into five main steps. These steps may include, but are not limited to: mining, blending and mixing, pressing, glazing, and firing. The process begins with the mining of the raw materials, which is a mixture composed of mostly clay and minerals. Next, mud is turned into fine sand. The clay and mineral mixture is blended and mixed into a semi fine powder. Water is added to form a wet slurry or mud-like consistency. Then the slurry is pumped into a large dryer, resulting in a fine clay powder. Next, the clay is pressed or formed into a tile shape. These pressed tiles are called green tiles at this stage. Alternatively, another method called extrusion may be used in order to replace the pressing step. Extruded tiles are formed by forcing the clay material through a mold for the desired shape instead of pressing the tile. After the green tiles are formed they are dried to remove some of the moisture. The next step is the glaze phase for those tiles that will have a glaze. However, if the tile is to remain unglazed then this step is omitted, and the tile may go directly into the firing kiln. The glaze liquid is prepared from a glass derivative called frit and colored dyes. The glaze is applied by either a high-pressure spray or is poured directly onto the tile. Next, the ceramic tiles may be fired in the kiln at temperatures around 2000 degrees Fahrenheit. Tiles that are fired once after the glaze is applied are called monocoturra tile or single fired. Another type of tile is called biocuttura or double fired tile. Biocuturra tiles are first fired after the green tile is dried and then fired again after the glaze is applied. Aside from the 2 types of ceramic tile, glazed and unglazed, there is another category that continues to gain popularity: porcelain tile. Porcelain tile is made up of 50% feldspar and is fired at a much higher temperature than regular ceramic tile. This makes porcelain tile much harder and more dense than other ceramic tile products.

Over time, tile is that is installed on the inside or the exterior of a building will need to be replaced in response to damage, wear and tear, and general deterioration. When replacing the tile in a certain section, it is likely the case that not all the individual tiles of the entire section need to be replaced. For example, if a single tile of a kitchen black splash chips or breaks, it is unnecessary to replace every tile that comprises the kitchen backsplash. As another example, if a section of roof tile is damaged by a storm, it is unnecessary to replace every roof tile on the roof. However, to avoid replacing every tile in a selected area, requires that the desired tile is still commercially available for purchase. If a certain tile has been discontinued, the installer up until now would be forced to replace all of the tile using a different, available tile. The labor, time, and material cost of replacing an entire tiled area are all much greater than the costs of only replacing selected tiles in need of replacing. Accordingly, there is a need for a way to create replicate tiles from existing tiles. The present disclosure includes a system and method for replicating a new tile from an existing tile through the combination of 3D scanning, CNC, and image, glazing, and/or photo application.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

Embodiments of the present invention comprise a system and method for repairing or replicating a building material. Embodiments of the present invention may serve as an effective means of replicating tiles that are no longer commercially available for purchase. Thus, embodiments of the present invention may provide an alternative to replacing all tiles in a given area where the original tiles have been discontinued or are otherwise not available or not suitable for installation. Furthermore, embodiments of the present invention may provide an effective means for replicating or repairing any building material.

Some embodiments may generally comprise the steps of 3D scanning, 3D printing, CNC, decoration, and firing. Embodiments of the present invention may include scanning an original tile to obtain an image data set, communicating the image data set to a computer, rendering a three-dimensional image of the original tile from the image data set, carving a new tile using a CNC machine based on the three-dimensional image of the original tile, applying a decorative image to the new tile, applying a glaze to the new tile, and firing the new tile.

Some embodiments may comprise additional steps for preparing the new tile for decoration. Some embodiments may comprise applying an ongo primer to the new tile, applying a base glaze to the new tile, and applying a sealer or fixture to the new tile.

Some embodiments may comprise applying a decorative image to the new tile using a commercial printer suitable for printing onto ceramic. Some embodiments may comprise applying a decorative image to the new tile using an inkjet printer. Some embodiments may comprise applying a decorative image to the new tile using a UV printer. Some other embodiments may comprise applying a decorative image to the new tile using a dye-sublimation printer. Some embodiments may comprise applying a decorative image to the new tile by methods including but not limited to, dipping, waterfall application, water slide decal, hand painting, spraying, lasering, etching, craving, or any combination of any of the aforementioned methods in the present disclosure.

Some embodiments may comprise firing the new tile in a kiln. Some embodiments may comprise firing the new tile in an electric kiln. Some embodiments may comprise firing the new tile in a gas kiln. Some embodiments may comprise firing the new tile in an oven. Some embodiments may comprise firing the new tile by way of oxidation firing. Some embodiments may comprise firing the new tile by way of reduction firing. Some embodiments may comprise firing the new tile using a combination of oxidation firing and reduction firing.

### BRIEF DESCRIPTION OF THE DRAWINGS

The following drawings are intended to serve as exemplary embodiments of the features disclosed in the present disclosure.

FIG. 1 is a flowchart illustrating an exemplary method for repairing or replicating a building material.

FIG. 2 is a diagram illustrating an exemplary system for repairing and replicating a building material.

### DETAILED DESCRIPTION OF DRAWINGS

The description of illustrative embodiments according to principles of several illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits are illustrated by reference to certain exemplified embodiments and may not apply to all embodiments.

Accordingly, the invention expressly should not be limited to such exemplary embodiments illustrating some possible non-limiting combination of features that may exist alone or in other combinations of features; the scope of the claimed invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

There presently exists a need to be able to replicate existing tiles that have been discontinued and are not commercially available. The various embodiments described herein describe a system and method relating to replicating new tiles from existing tiles.

In accordance with the present disclosure, the term “material” shall include, but is not limited to, tile, clay, cement, porcelain, wood, brick, stone, stucco, wood, engineered wood, laminate, vinyl, metal, copper, brass, plastic, cork, MDF, plywood, shingles, lumber, sand, plaster, glass, rubber, silicon, and any combination thereof and the like. Material shall likewise refer to building, construction, restoration, and/or new development material. Material may be fully dry, semi dry, wet, damp, or sweating.

In further accordance with the present disclosure, “scan” is defined as any process used to capture data of an object or material, whether by use of machine, instrument, mold, technology, hand capture, or the like. Data captured consists of size, measurement, color, texture, material, decoration, weight, sheens and finishes, or any combination thereof.

In accordance with the present disclosure, “decoration” is defined as any modification of material to alter, distort, change, enhance, correct, apply or similar, a color, glaze, undercoat, decal, finish, sheen, texture, veining, or the like, to whole or part of the material. Decoration may be applied by machine, printing, dipping, waterfall application, hand painting, spraying, lasering, etching, craving, as well as by other methods known to one having skill in the art.

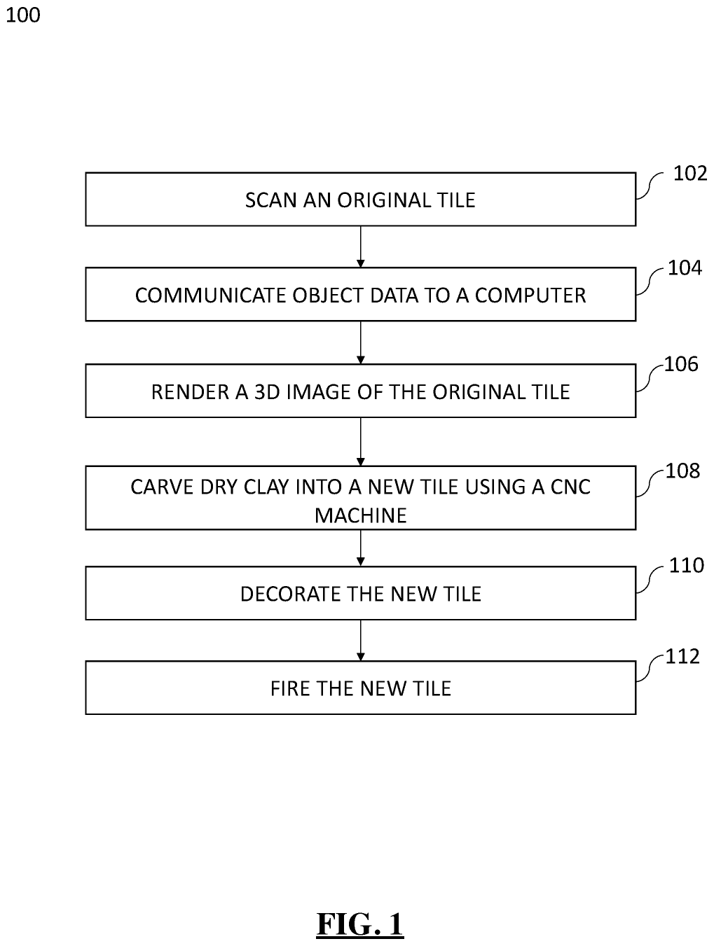

FIG. 1 is a flowchart illustrating a method of repairing or replicating a building material using three-dimensional scanning and a computer numerical control (“CNC”) machine.

In accordance with FIG. 1, the method 100 may include, but is not limited to, the following steps: scanning an original tile to obtain an image data set, communicating the image data set to a computer, rendering a three-dimensional image of the original tile from the image data set, placing a material on a workspace, carving the material using a CNC machine to produce a new tile resembling the original tile, applying a decorative image to the new tile, applying a glaze to the new tile, and firing the new tile.

First, at step 102, an undamaged tile is three-dimensionally scanned. In accordance with the present disclosure, 3D scanning allows a user to capture a physical object's exact size and shape as a digital 3-dimensional representation that may be viewed and manipulated on a computer. A 3D scanner works with structured light using the principles of triangulation. The sensor projects a precise shifting fringe pattern across the part's surface, and two cameras capture the surface geometry based on the pattern distortion, calculating 3D coordinate measurements. 3D scanners create “point clouds” of data from the surface of an object. 3D scanners measure fine details and capture free-form shapes to quickly generate highly accurate point clouds. After the huge point cloud data files are created, they are registered and merged into one three-dimensional representation of the object and post-processed with various software packages suitable for a specific application. The CAD model produced by 3D scanning enables the precise reproduction of the scanned object, or the object can be modified in the CAD model to correct imperfections. Accordingly, obtaining a three-dimensional scan may provide certain parameters of the original target tile, including the size, dimensions, shape, color, material, and as well as other properties related to the tile, including patterns and other decorative properties.

This disclosure contemplates the inclusion of at least one machine learning technique that may aid in generating 3D images. For example, it may be the case that there are no undamaged original tiles that are available. In this scenario, a machine learning technique including the use of interpolation may be used to generate a perfect 3D image of a tile where no perfect tile is available. Interpolation is a type of estimation method of constructing new data points based on the range of a discrete set of known data points. Accordingly, a machine learning technique may be used to add additional data points to the point cloud described above, which may aid in rendering a more precise three-dimensional graphical representation of the tile that is scanned.

Additionally, machine learning techniques may be included for to serve other purposes as well. For example, using machine learning may enable one to determine the material from which the tile is comprised from. In some embodiments, given that different materials may have differing porosities, a machine learning based algorithm may be able to predict the material of the tile based on the porosity of that material. It should be understood by one of skill in the art that terms such as “machine learning”, “artificial intelligence”, and the like are to be construed as having the same meaning and may be used interchangeably.

Next, at step 104, after an image data set is obtained from 3D scanning the original tile, the image data set is communicated to a computer. Next, at step 106, the image data set is used to create a computer aided design (“CAD”) of the original tile. The CAD then may be manipulated or altered based on the user's preferences. For example, it is contemplated that the user may want to alter the CAD of the original tile to suit specific installation needs or stylistic preferences.

Next, at step 108, a new tile may be carved from dry clay or other material using a CNC machine. Computer numerical control (“CNC”) is the automated control of machining tools (such as drills, lathes, mills, grinders, routers and 3D printers) by means of a computer. A CNC machine may process a piece of material to meet specifications by following coded programmed instructions and without a manual operator directly controlling the machining operation. In some embodiments, the CNC machine may comprise from a motorized maneuverable tool and a motorized maneuverable platform, which are both controlled by a computer, according to specific input instructions or program. In accordance with the present disclosure, the program may be generated by graphical computer-aided design (CAD) or computer-aided manufacturing (CAM) software. In accordance with the present disclosure, after a CAD has been generated from three-dimensionally scanning the original tile, the CAD may then be used to generate a program to instruct the CNC machine how to cut the material into a new tile replicating the original tile.

Once the new tile has been carved, it is ready to be prepared for image application. The specific preparation process may include, but is not limited to, the following steps: applying an ongo primer to the new tile, applying a base glaze to the new tile, and applying a sealer or fixture to the new tile.

Next, at step 110, a decorative image is applied to the new tile. In accordance with the present disclosure, a decorative image may be applied to the tile using a commercial tile decorating machine. In some embodiments, the tile decorating machine may be a commercial inkjet printer configured to input an image onto ceramic tile. In general, inkjet technology offers two different options when printing on ceramics. One option is to use a primer coat before printing a single- or four-color image on a ceramic substrate. Primer provides a solid foundation for the coat of paint, or, in the case of printing, the ink. The other option is to use UV-curable ink that may not require the need for a primer base when printing on ceramics. UV-curable ink hardens when exposed to a mercury arc lamp during the curing process. The light waves from the mercury arc lamp excite the ink molecules, making the ink bind to the smooth, hard surface of ceramic substrates (such as tiles), creating durable, high image quality. The unique chemical formula of the ink reacts to the broad spectrum of the mercury lamp. This causes the ink to develop a solid film coating, allowing it to dry instantly. Another advantage of using UV-curable ink is that there are no volatile organic compounds (VOC) emitted. There are a number of different inkjet technologies that may be used to accomplish the aim of the present invention. The following disclosure contemplates the use of Drop On Demand, Spray On Demand, Drops of Variable Size, and/or any combination thereof. While this invention includes the specific use of inkjet printing for image application, it is contemplated that other image application techniques may be used, including but not limited to, water slide decal, dipping, hand painting, spray painting, machine painting, and the like. Furthermore, while this invention includes the specific use of an inkjet printer, it is contemplated that other types of machines may be used for applying decoration to a tile, including but not limited to: UV printer, Dye-Sublimation Printer, 3D Printer, ceramic screen printer, or any other suitable machine for applying decoration to a tile.

Finally, at step 112, the new tile is fired. In some embodiments, the new tile is fired in a kiln. The present disclosure contemplates that using alternative methods of firing may be suitable to achieve the invention in the present disclosure. Accordingly, tiles may be fired using the following techniques, including but not limited to: Oxidation firing, Reduction firing, firing using an Electric Kiln, firing using a Gas Kiln, firing using a Wood Burning Kiln, firing using an oven, Soda Firing, Raku Firing, Sawdust Firing, Pit/Barrel Firing, and any combination thereof.

There are generally two ways to fire ceramics: oxidation firing and reduction firing. Oxidation firing occurs when there is a large supply of oxygen in the kiln, and the oxygen is free to interact with the glazes when firing. When a kiln heats up to a high enough temperature, compounds and molecules in the glaze and clay break off. The oxygen molecules then attach to the ceramic and interact with the remaining glaze and clay surface. Because oxygen has high electronegativity, oxygen may strongly attract electrons from other substances. Accordingly, the oxygen attracts electrons from the glaze and clay and subsequently causes them to oxidize. Oxidation firing is typically done in an electric kiln but can also be done in a gas kiln. Oxidation firing may allow very bright, rich colors. Both high temperatures as well as low temperatures may be used for oxidation firing. Reduction firing includes firing where the kiln atmosphere has insufficient oxygen for complete combustion. Reduction firing occurs when the amount of free oxygen in a kiln is restricted, and as a result, gasses such as carbon, hydrogen, and carbon monoxide build up. These gasses leach out oxygen from the metallic oxides in the clay and glazes, and the oxides then take on a reduced and concentrated form, which may affect the color and texture of the oxides.

It is contemplated that because oxidation and reduction are different processes, the same glaze may look very different when fired in either atmosphere. In some embodiments oxidation firing may be used. In some other embodiments, reduction firing may be used. In some other embodiments, the atmosphere of the kiln may be neutral. It is further contemplated that a combination of oxidation and reduction may be used during firing, which may enable the creation of specific finishes. It is further contemplated that the amount of oxygen in the kiln may be controlled and manipulated to produce a specific desired finish. In some embodiments, firing may be accomplished using an electric kiln. In some other embodiments, tiles may be fired in a gas kiln. In some other embodiments, tiles may be fired in a wood burning kiln. In some other embodiments, tiles may be fired in an oven.

Kilns are generally either electric or fuel burning. Fuel-burning kilns burn fuel such as gas, wood, oil, and/or and other combustible material to heat an inner chamber of the kiln. Electric kilns are lined with coiled metal elements, through which electrical current flows. The resistance in the coil creates heat, which effectively heats the kiln chamber using conduction, convection, and radiation. In some embodiments, tiles may be fired in an electric kiln. In some embodiments, the electric kiln may have neutral atmosphere for firing. In some other embodiments, the electric kiln may have an oxidizing atmosphere.

In some embodiments, tiles may be fired in a gas kiln. Accordingly, a gas kiln may be used for reduction firing, and salt or soda firing. The gas kiln may be configurable to use combustion to heat the insulated internal cavity. In some embodiments, the gas kiln may burn natural gas, propane, or any other suitable fuel. The ratio of fuel to oxygen in a kiln will determine how the flame burns, which will affect how the clay fires. In some embodiments, the gas kiln is set so the mix of fuel and air is fuel lean. When the mixture is lean, the flame will be shorter and cleaner. In some other embodiments, the gas kiln is set so the mix of fuel and air is oxygen lean. When the amount of air is reduced and the mix becomes richer, the flame gets long and produces sooty smoke. In this atmosphere, carbon monoxide is created and begins the reduction firing process. Accordingly, because the natural state of carbon is carbon dioxide, to return to this state, the carbon monoxide draws oxygen out of the glaze and clay. In some embodiments, the gas kiln may be a downdraft kiln. In some other embodiments, the gas kiln may be an updraft kiln.

In some embodiments, tiles may be fired in a wood firing kiln. Wood firing is a process of firing clay that includes burning wood to heat the kiln chamber. In some embodiments, a specifically designed wood firing kiln is used. In some other embodiments, tiles may be fired in an oven. In some embodiments, the oven may be a large commercial oven suitable for mass firing ceramics.

In some embodiments, firing the new tiles may include salt firing. Salt firing is a process that includes introducing salt fumes into the kiln chamber. In some embodiments, the salt in the salt spray used may be sodium chloride. In other embodiments, the salt spray may comprise soda ash. Accordingly, salt fumes may be introduced by a spray into the burner ports of a kiln to form a vapor cloud in the kiln, wherein the salt vapor cloud may combine with the silica and alumina in the clay to form a glass to glaze the ware. It is contemplated that ceramics that contain high silica may be the most suitable for salt firing. In some embodiments, salt firing may be accomplished using a commercial machine designed for salt firing.

In some embodiments, firing the new tiles may be accomplished by sawdust firing. Saw dust firing includes placing ceramics into a structure, filling the structure with sawdust so to surround each ceramic in the kiln, starting the sawdust on fire, closing the structure, and leaving the structure to smolder until all the sawdust has been consumed. Ceramics may be subsequently removed from the structure after all the sawdust has been consumed and firing has been completed.

In some embodiments, firing the new tiles may be accomplished by pit firing. Pit firing includes the use of a large hole or “pit” dug in the ground, placing the ceramics in the pit, filling the pit with wood or other fuel, starting the wood on fire, and covering the pit with dirt and leaving it to smolder. Ceramics are subsequently removed from the pit after all the fuel has been consumed and firing has completed.

In some embodiments, firing the new tiles may be accomplished by Raku firing. Raku firing includes heating a ceramic until the ceramic is glowing, then pulling the ceramic out with tongs from the kiln, and placing the ceramic into a reduced atmosphere, such as, for example, a metal can full of pine needles, newspaper, leaves, or the like. After the ceramic piece has been somewhat cooed, the piece may be subsequently plunged into cold water, creating crackle effects. During Raku firing, unglazed areas of clay may become black due to the carbon from the burning fuel. When the carbon is scrubbed off the glazed areas they are often bright metal colors, such as copper and bronze. In some embodiments, Raku firing may be accomplished using a commercial machine designed for Raku firing.

In summary, the method 100 disclosed in the present disclosure may be performed in the following manner: scanning an undamaged tile, rendering a 3D image (i.e., CAD) of the tile, placing a piece of dry clay on a work area, engraving texture onto the dry clay using a CNC machine and turning the dry clay into a new tile, applying an image to the new tile, coating the tile in glaze after the image is applied, and firing the new tile. Depending on the image being reproduced, a primer spray may be applied before the decoration machine inputs the image onto the new tile. Also, depending on the tile being reproduced, a final dry layer may be applied to assist with slip resistance.

Furthermore, in accordance with the present disclosure, after the replicated material has been produced, the new tile moves through a multistep process of applying multiple different layers of materials covering. Material covering may include, but are not limited to: primers, sealers, glazes, sand, liquid, solids, water, grits, textures, ongo, coloring, decoration, and the like. These material coverings may be gas, liquid, solid, or combination thereof. The material coverings may be applied fully or partially to replicated material. Material coverings may be applied in various ways, including but not limited to: hand applied, sprayed, machine applied, printed, dipped, engulfed, waterfall method, or by any other method of applying material covering to replicated material. After replicated material goes through required layers of material coverings, the material is heated (fired) to completion. Firing temperate, method, and duration varies but can be between 1 degree F. and 5000 degrees F. The length of time of firing can range from 1 minute up to 33 hours. In some embodiments, the replicated material may be subsequently cleaned, polished, enhanced, and the like.

In accordance with the present disclosure, the specific manufacturing process after the new tile has been dried, but before the tile has been fired can be achieved in the following exemplary manner. First, the dried tile is coated with an ongo primer. Next, a base glaze is applied to the tile. Accordingly, the base glaze may be applied by spray method using a machine. Next, after the base glaze is applied, a fixture or sealer may be applied, likewise by spray method. Next, after fixture or sealer is applied, the tile moves onto decoration stage of production. In accordance with the present disclosure, the decoration may be applied by an inkjet printer or by any other suitable printer or machine configurable for applying decoration to a tile. Next, after the tile is decorated, the tile may be fired. Finally, after the tile has been fired, the new tile may be polished, cleaned, enhanced, or any combination thereof.

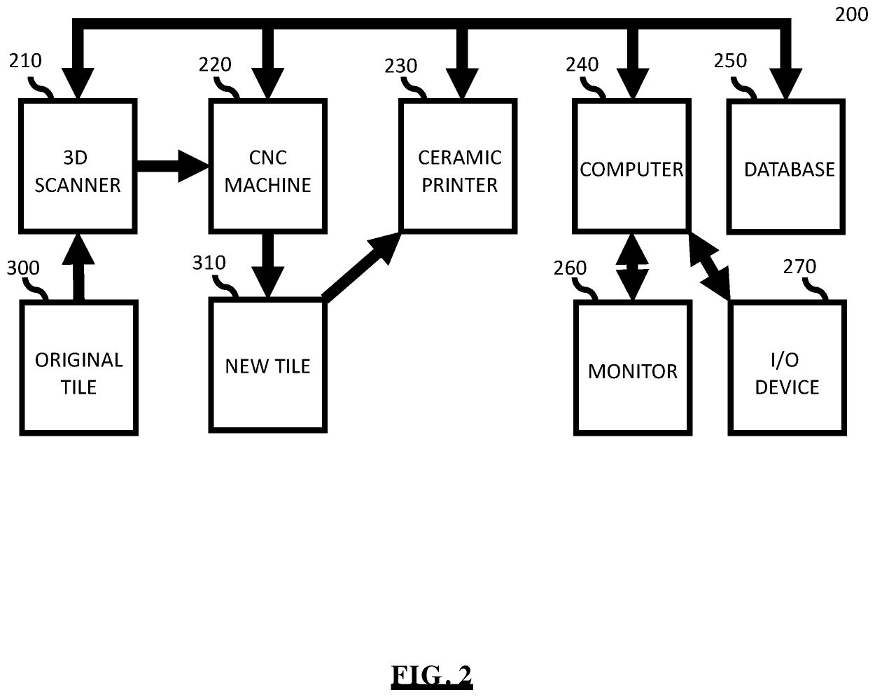

FIG. 2 is a diagram illustrating an exemplary system for repairing or replicating a building material using three-dimensional printing, in accordance with the present disclosure. With continued reference to FIG. 2, the system may include, but is not limited to: a 3-D scanner 210, a CNC machine 220, a printer 230, a computer 240, and a kiln 250. The 3D scanner 210 may be any type of 3D scanner suitable for obtaining three-dimensional images of a tile, as described in greater detail herein the present disclosure. The CNC machine may be any CNC machine suitable for carving texture onto a ceramic tile, in accordance with the present disclosure. The primer 230 may be any type of printer suitable for applying images to tile, as described in greater detail herein the present disclosure. The computer 240 may be any type of computer suitable for communicating between the 3D scanner 210, the CNC machine 220, the printer 230, and/or the database 250 as described in greater detail herein the present disclosure.

With continued reference to FIG. 2, the computer may include a processor, a memory, and set of instructions stored on the memory, that when executed by the processor, cause the computer to perform a series of steps, including but not limited to, scanning an original tile, rendering a three-dimensional image of the original tile, carving a material into a new tile based on the three-dimensional image, and applying a decorative image. The memory may include both a read-only memory (“ROM”) and a random-access memory (“RAM”). As will be appreciated by those of ordinary skill in the art, both the ROM and the RAM may store software instructions for execution by the processor.

The processor and memory may be connected, either directly or indirectly, through a bus or alternate communication structure to one or more peripheral devices. For example, the processor and/or the memory may be directly or indirectly connected to additional memory storage, such as the hard disk drive, the removable magnetic disk drive, the optical disk drive, and the flash memory card. The processor may also be directly or indirectly connected to one or more input devices and one or more output devices. The input devices may include, for example, a keyboard, a touch screen, a remote control pad, a pointing device (i.e., mouse, touchpad, stylus, trackball, joystick, etc.), a scanner, a camera, and/or a microphone. The output devices may include, for example, a monitor, haptic feedback device, television, printer, stereo, and/or speakers.

Furthermore, the computing unit may be directly or indirectly connected to one or more network interfaces for communicating with a network. This type of network interface, which may also be referred to as a network adapter or network interface card (“NIC”), may translate data and control signals from the computing unit into network messages according to one or more communication protocols. The communication protocols may include, but are not limited to, Transmission Control Protocol (“TCP”), the Internet Protocol (“IP”), and/or User Datagram Protocol (“UDP”). An interface may employ any suitable connection agent for connecting to a network, including but not limited to, a wireless transceiver, a power line adapter, a modem, and/or an Ethernet connection.

Furthermore, in addition to the input, output, and storage peripheral devices specifically described hereinabove, the computing device may be connected to a variety of other peripheral devices, including some that may perform input, output, and storage functions, or some combination thereof.

Furthermore, the computer 240 may be configured to communicate with a database 250. The database may contain historical data and other data related to tiles, tile manufacturing, and the like.

In some embodiments, the system 200 may be manufactured as a single self-contained machine. In some other embodiments, the system 200 may be accomplished as separate machines all directly or indirectly in communication with one another. In some embodiments, the whole process for repairing or replicating a building material is entirely automated. In some other embodiments, some steps may be automatically executed using a computer without the need of any human supervision or intervention, while some other steps are executed by a human user and may require human supervision or intervention.

In some embodiments, the elements of the replicate tile correspond identically to the elements of the target tile. In some other embodiments, the elements of the replicate tile do not correspond identically to the target tile. As a non-limiting illustrative example, while a target tile may be the color red, the replacement tile may be the color blue, or vice versa. Some of the possible similarities and differences between the replacement tile and the target tile are described in greater detail hereinbelow.

In some embodiments, the replicated tile shape is the same as the desirable target tile shape. In other embodiments, the replicated tile shape is different from the desirable target tile shape. It is contemplated that in some instances the tile installer may benefit from using a replicated tile that is a different shape than the shape of the target tile. For example, it may be the case that a certain surface area may be a nonstandard shape or have nonstandard dimensions, making standard tile sizes difficult to install. The shape of the replicated tile may be formed to accommodate the shape of the surface on which the tile will be installed, regardless of the shape of the original target tile.

In some embodiments, the replicated tile size is the same as the desirable target tile size. In other embodiments, the replicated tile size is different from the desirable target tile size. It is contemplated that in some instances it may be preferable for the tile installer to use a replicated tile that is a different size from the original target tile size. For example, the original target tiles may have a dimension of 4″×6″. However, it may be preferable for the installer to use tiles that have a dimension of 8″×12″. In such case, the replicated tile size may be larger than the original target tile size.

In another instance, the installer may need to use tiles that have multiple different dimensions in order to adequately tile a certain space. As an illustrative example, if a space is 40″×60″ and 4″×6″ tiles are used, and assuming the gap size between tiles is 0″, then to completely tile the space would require 100 4″×6″ tiles. However, if the space were a different dimension, for example, 39″×60″, and also assuming a gap size of 0, then one possible solution to completely fill the space would be to use 90 4″×6″ tiles and 10 3″×6″ tiles, which would require the installer to cut 10 4″×6″ tiles into 3″×6″ tiles. Thus, if a surface area is 39″×60″, and the installer would like to use 100 4″×6″ tiles, the installer would have to cut 1″ from 10 tiles in order to meet the dimension requirements. In reality, there will be a gap size greater than 0″ between tiles, thus cutting tiles is nearly inevitable to fit dimension requirements unless custom dimension tiles are used. Not all tiles are equally easy to cut and cutting some tile may inevitably cause the tile to crack or chip. Replicating tiles in accordance with the present disclosure provides an alternative to cutting tiles reduces the amount of waste created during tile installation.

Furthermore, it is usually recommended that an installer purchase ten-percent additional tile material than is necessary to cover a certain desired space. The additional ten-percent material is used to compensate for damaged tile during installation. By using tiles that are the exact size and shape as required for installation, less additional tiles may need to be purchased.

In some embodiments, the replicated tile material is the same as the desired target material. In other embodiments, the replicated tile material is different from the desired target material. It is contemplated that in some instances it may be desirable to use a tile material that is different from the original target material. For example, a person may want to install marble appearing tile in their bathroom. However, marble tile is usually more expensive than ceramic tile. In such a circumstance, the person may want to replicate a certain style of marble tile out of material such as ceramic or porcelain.

In some embodiments, the replicated tile shape is the same as the desired target tile shape. In some other embodiments, the replicated tile shape is different from the original target shape. It is contemplated that in some instances it may be desirable to use a tile that is a different shape that the original tile shape. For example, when installing tiles in a shower, different shaped tiles may need to be used to account for a drain opening in the shower pan. It is contemplated that the replacement tiles may be formed in a shape to allow for the incorporation of a shower drain, thus eliminating the need for an installer to cut tiles, and instead allows the installer to install custom shaped tiles to match the surrounding shower floor tiles.

In some embodiments, the replicate tile may be replicated from scanning a physical existing original target tile. In some other embodiments, the replacement tile may be replicated from a different target medium, such as for example, a photograph. It is contemplated that in some instances it may be preferable to replicate a tile from a photograph instead of from a physical tile. For example, it may be the case that a physical tile is unavailable to be used. Alternatively, it may be the case that the existing physical tile is not desirable to be replicated. For example, tiles that are very old may have experienced color fading or other forms of deterioration. Accordingly, sunlight is the most common cause of fading tile colors over time. Thus, it may be preferable to replicate a tile using the colors from a photograph, rather than the colors from a physical tile. In some other embodiments, the color of the replicate tile may be altered to be any color, and specific colors values for the replicate tile may be selected.

In accordance with the present disclosure, the invention disclosed herein may be used to used to replicate any tiles from any era. For example, an installer may be interested in using tiles formed from materials that mimic traditional Babylonian era materials and material proportions, which may be achieved using the invention disclosed herein the present disclosure.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method for replicating a building material, the method comprising the steps of scanning an original tile to obtain an image data set,
communicating the image data set to a computer,
rendering a three-dimensional image of the original tile from the image data set,
carving a new tile using a CNC machine based on the three-dimensional image of the original tile,
applying a decorative image to the new tile,
applying a glaze to the new tile, and
firing the new tile.

2. The method of claim 1, wherein the decorative image is applied to the new tile using an inkjet printer.

3. The method of claim 1, wherein the decorative image is applied to the new tile using a UV printer.

4. The method of claim 1, wherein the decorative image is applied to the new tile using a dye-sublimation printer.

5. The method of claim 1, wherein the decorative image is applied to the new tile using a ceramic screen printer.

6. The method of claim 1, wherein the new tile is fired using an electric kiln.

7. The method of claim 1, wherein the new tile is fired using a gas kiln.

8. The method of claim 1, wherein the new tile is fired by way of oxidation firing.

9. The method of claim 1, wherein the new tile is fired by way of reduction firing.

10. The method of claim 1, wherein the new tile is fired using a combination of reduction firing and oxidation firing.

11. The method of claim 1, further comprising the step of applying an anti-slip protectant to the new tile.

12. The method of claim 1, wherein the method further comprises the step of preparing the new tile for decoration, wherein preparing the new tile for decoration comprises the steps of:
applying an ongo primer to the new tile,
applying a base glaze to the new tile, and
applying a sealer to the new tile.

13. A system for replicating a building material, the system comprising
a 3D scanner, wherein the 3D scanner is configurable to obtain a three-dimensional image of an original tile,
a CNC machine, wherein the CNC machine is configurable to carve a new tile from a desired material,
a printer, wherein the printer is configurable to apply an image onto the new the carved by the CNC machine,
a firing containment, wherein the firing containment is configurable to fire dry the new tile, and
a computer, the computer comprising a processor, a memory, and a set of instructions stored on the memory, wherein when the set of instructions are executed by the processor, cause the computer to
actuate the 3D scanner to scan an original tile,
produce a three-dimensional image of the original tile,
display the three-dimensional image on a peripheral screen,
actuate the CNC machine to carve a new tile from a desired material,
actuate the printer to apply an image onto the new tile carved using the CNC machine, and
actuate the firing containment to fire dry the new tile.

14. The system of claim 13, wherein the printer is an inkjet printer.

15. The system of claim 13, wherein the printer is a UV printer.

16. The system of claim 13, wherein the printer is a ceramic screen printer.

17. The system of claim 13, wherein the printers a dye-sublimation printer.

18. The system of claim 13, wherein the firing containment is an electric.

19. The system of claim 13, wherein the firing containment is a gas kiln.

20. The system of claim 13 wherein the firing containment is an oven.
